(19) United States
(12) Patent Application Publication
(10) Pub. No.: US 2025/0328478 A1
(43) Pub. Date: Oct. 23, 2025

(54) TECHNIQUES FOR MULTIPLE ISOLATIONS FOR SHARED MEMORY

(71) Applicant: Intel Corporation, Santa Clara, CA (US)

(72) Inventors: Akhilesh S. THYAGATURU, Ruskin, FL (US); Jason M. HOWARD, Portland, OR (US); Gurpreet Singh KALSI, Portland, OR (US)

(21) Appl. No.: 19/254,619

(22) Filed: Jun. 30, 2025

(51) Int. Cl. G06F 12/14; G06F 15/167

(52) U.S. Cl. CPC G06F 12/14; G06F 15/167

(57) ABSTRACT

Examples include techniques associated for multiple isolations for shared memory. Examples include the shared memory being included on or at an externally-attached shared memory device. The shared memory at the externally-attached shared memory device can be shared between multiple domains hosted by one or more host computing platforms. The multiple isolations to be established for memory access transactions to the shared memory by one or more domains that can access the shared memory.

### BACKGROUND

A data center may include one or more computing platforms each comprising at least one processor and associated memory modules. Each computing platform of the datacenter may facilitate the performance of any suitable number of processes associated with various applications running on and/or hosted by computing platform. These processes may be performed by the processors and other associated logic of the computing platforms. Each computing platform may additionally include I/O controllers, such as network adapter devices, which may be used to send and receive data on a network for use by the various applications.

In some examples, an externally-attached shared memory device (ESMD) can be used for low-latency, external inter-process communication (IPC) between computing platforms. With memory sharing via an ESMD, external IPC between computing platforms can be possible at high bit rates. External IPC at high bit rates can be possible because memory sharing can involve read and write operations in a same memory region of a memory maintained at the ESMD. These read and write operations can thereby avoid overhead associated with copying data between different address spaces of memory separately maintained at respective computing platforms.

### BRIEF DESCRIPTION OF THE DRAWINGS

FIG. 1 illustrates an example first system.

FIG. 2 illustrates example controlled shared memory (COSM) management circuitry.

FIG. 3 illustrates an example second system.

FIG. 4 illustrates an example isolation scheme.

FIG. 5 illustrates an example first permission matrix scheme.

FIG. 6 illustrates an example second permission matrix scheme.

FIG. 7 illustrates an example data transfer scheme.

FIG. 8 illustrates an example isolation process.

FIGS. 9 illustrates an example logic flow.

FIG. 10 illustrates an example storage medium.

### DETAILED DESCRIPTION

In some examples, an externally-attached shared memory device (ESMD) can be used for low-latency external inter-process communication (IPC) between host computing platforms. In some examples, ESMD can also be referred to as an enclave secured memory device. Also as contemplated by this disclosure, low-latency external IPC can be obtained by read and write operations that access a same memory region of a memory maintained at an ESMD rather than copying data between different address spaces of memory separately maintained at respective host computing platforms. However, current implementations of memory sharing between processes hosted by separate computing platforms lack strict isolation mechanisms. These current implementations typically enforce coarse-grained access control but lack deep data-level security. Coarse-grained access control that lacks deep data-level security can lead to several security vulnerabilities. The security vulnerabilities can include unrestricted read/write access between computing platforms and/or tenants supported by the same or different computing platforms, lack of real-time data inspection. The security vulnerabilities can also include a lack of real-time data inspection that can make it difficult to enforce content policies. The security vulnerabilities can also include an inability to dynamically block, delete, modify, or regulate access to shared memory based, at least in part, on a data format validation. This disclosure describes example techniques to implement an isolation mechanism for shared memory that includes host-level access control as a first isolation and data-level inspection and policy enforcement as a second level of isolation. This isolation mechanism can reduce, minimize or possibly eliminate the security vulnerabilities mentioned above.

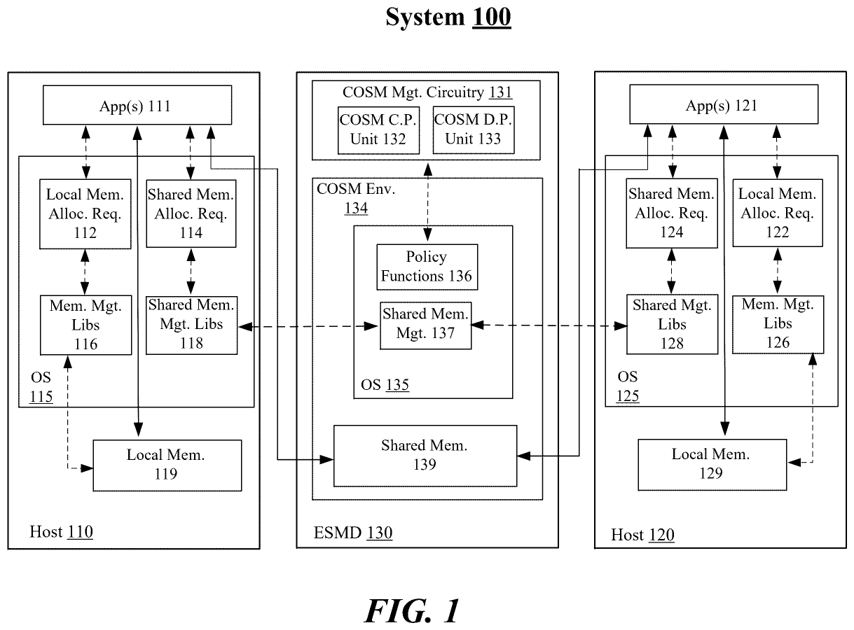

FIG. 1 illustrates an example system 100. According to some examples, as shown in FIG. 1, system 100 includes a host 110, a host 120 and an externally attached shared memory device (ESMD) 130. Also as shown in FIG. 1, host 110 can be configured to host one or more applications (App(s)) 111, an operating system (OS) 115 and maintain or include a local memory 119. Also, host 120 can be similarly configured to host one or more applications 121, an OS 125 and maintain or include a local memory (mem.) 129. In some examples, application(s) 111 and application(s) 121 can place a respective local memory (mem.) allocation (alloc.) request (req.) 112, 122 to respective OSs 115, 125 for use of and/or access to one or more memory regions maintained in respective local memories 119, 129. For these examples, OS 115 and OS 125 can use their respective memory (mem.) management (mgt.) library (libs.) 116, 126 to allocate memory regions maintained in respective local memories 119, 129 to allow application(s) 111 and 121 to access these respective local memories.

According to some examples, as shown in FIG. 1, ESMD 130 includes controlled shared memory (COSM) management (mgt.) circuitry 131, an OS 135 and shared memory 139. Also as shown in FIG. 1, and described in more detail below, COSM management circuitry 131 can include a COSM control plane (c.p.) unit 132 and a COSM data plane (d.p.) unit 133 that can be arranged or configured to set up and implement/enforce an isolation mechanism for access to one or more shared memory regions maintained in shared memory 139. A COSM environment (env.) 134 can be established at ESMD 130 by COSM management circuitry 131 that can include OS 135 implementing policy functions 136 and shared memory (mem.) management (mgt.) 137 for access to one or more memory regions maintained in shared memory 139 based on the isolation mechanism that can include two levels or two separate isolations. This isolation mechanism, as will be described more below, can include host-level access control as a first isolation and data-level inspection and enforcement as a second isolation. For example, respective application(s) 111, 121 can place a respective shared memory allocation request 114, 124 to respective OSs 115, 125 for use of and/or access to the one or more memory regions maintained in shared memory 139. OSs 115, 125 can be configured to coordinate with shared memory management 137 via establishment of respective shared memory (mem.) management (mgt.) libraries (libs) 118, 128 to enable application(s) 111 or application(s) 121 to access one or more memory regions maintained in shared memory 139 based, at least in part, on policy or rules enforced by policy functions 136.

Local memories 119, 129 or shared memory 139 can include volatile and/or non-volatile types of memory. In some examples, local memories 119, 129 or shared memory 139 can include one or more dual in-line memory modules (DIMMs) that are arranged to include any combination of volatile or non-volatile memory. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random-access memory), or some variant such as synchronous DRAM (SDRAM).

Although not shown in FIG. 1, host 110, host 120 or ESMD 130 may include additional components that facilitate inter-process communications and use of shared memory 139. For example, various network and/or internal communication interfaces and associated interconnects can communicatively couple the elements shown in FIG. 1 to each other or to elements on other hosts or ESMDs (not shown in FIG. 1).

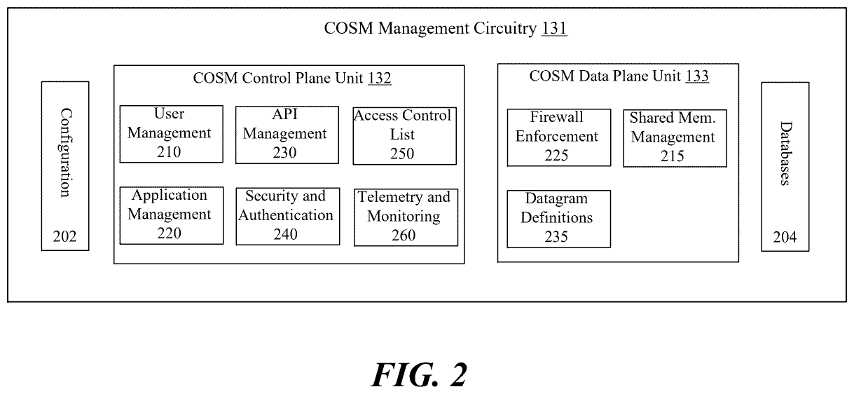

FIG. 2 illustrates example COSM management circuitry 131. In some examples, FIG. 2 shows example logical modules, configurations or databases that can be implemented by hardware circuitry, firmware, and/or software executed on an ESMD such as ESMD 130. For these examples, The COSM management circuitry 131 may include a COSM control plane unit 132 and a COSM data plane unit 133. The COSM control plane unit 132 may be responsible for managing the configuration and establishment of memory-based communication channels in ESMD 130. With a memory-based communication channel configured, the COSM data plane unit 133 may manage operation of the memory-based communication channel following configuration, enforcing isolation policies and providing services to be used in the respective memory-based communication channels based on the configurations.

According to some examples, ESMD 130 can include two or more I/O ports to couple to devices representing different hosts or host domains via one or more I/O interfaces. A domain can be defined as a set of system resources (e.g., hosts), to which certain users can have prescribed access rights as governed by security policies or service level agreements. The COSM control plane unit 132 can interface with the attached devices to present ESMD 130 as a memory device (e.g., sharable memory device) accessible by the attached devices via their respective interconnect. For example, interconnects arranged to operate using peripheral component interface express (PCIe) protocols, compute express link (CXL) protocols, Ethernet protocols and/or other type of interconnect protocols. User management 210 can be arranged to identify a particular device, operating system, hypervisor, etc. of a host or host domain and determine attributes of the corresponding host and/or host domain, including policies and configurations to be applied for the host and/or host domain. User management 210 can further identify various applications (e.g., applications, services, processes, virtual machines, or threads) that can run on the host or host domain's OS or hypervisor and that may utilize communication channels implemented by ESMD 130. Application management 220 may identify, for the applications of each host and/or host domain, attributes, permissions, policies, and preferences for the applications so as to configure the manner in which individual applications can access and use memory-based communication channels (and their corresponding buffers or memory regions) implemented in ESMD 130. For instance, a single buffer/memory region or memory-based communication channel configured in ESMD 130 (e.g., maintained in shared memory 139) to enable communication between two or more host and/or host domain devices can be called upon, in some examples, to be used by multiple, distinct applications of a host and/or host domain, and application management 220 can configure the memory-based communication channel to establish isolation rules and policies that can govern how or if the applications share the memory-based communication channel, among other example configurations and considerations.

Continuing with the example of FIG. 2, API management 230 can be provided in some implementations to assist in configuring ESMD 130 and respective memory-based communication channels configured in ESMD 130 to interoperate in a system where ESMD 130 couples through an external switch or another ESMD to one or more host or host domains, with the memory-based communication channel being configured to consider the routing, protocols, and other attributes of the potential one-to-many coupling of ESMD 130 to potentially multiple distinct host or host domains through a single input/output (I/O) interface of ESMD 130, among other examples. Security and authentication 240 can be arranged to define and enforce security and authentication protocols (e.g., at the host, host domain or application level) for the memory-based communication channels, such that specific security features and/or policies are configured for the memory-based communication channels. Further, an access control list 250 can govern types of allowed or non-allowed accesses to ESMD 130. For example, enforcing access controls and permissions of the configuration port of an ESMD such as ESMD 130. Telemetry monitoring can also be managed for memory-based communication channels of specific hosts, host domains and/or applications. For instance, in accordance with QoS guarantees for various domains or applications. Telemetry monitoring access can be controlled using telemetry monitoring manager 260, among other example modules and logical blocks.

The COSM management circuitry 131 of an example ESMD such as ESMD 130 can additionally include COSM data plane unit 133 to govern the operation of various memory-based communication channels (and corresponding buffers or memory regions) configured in the shared memory maintained at ESMD 130 (e.g., shared memory 139) in accordance with configurations 202. Configurations 202, for example, can be set or implemented using COSM control plane unit 132. Individual buffers, memory regions and memory-based communication channels can have respective functionality, rules, protocols, and policies defined for the channel, and these channel or buffer definitions may be recorded within database 204. The COSM data plane unit 133 may include, for instance, shared memory management 215 to identify one or more portions of shared memory (e.g., buffers or memory regions) maintained at ESMD 130 to allocate for a specific memory-based communication channel and define pointers to provide to the host or host domain devices that are to communicate over the memory-based communication channel to enable the devices' access to the memory-based communication channel. Shared memory management 215 can leverage these pointers to effectively “turn off” or at least limit a device's or application's access and use of the memory-based communication channel by retiring the pointer, disabling the device's ability to write data on the buffer (to send data on the communication channel) or read data from a buffer (to receive/retrieve data on the communication channel), among other example functions. Other security and data filtering functions may be available for use in a memory-based communication channel, based on the configuration and/or policies applied to the memory-based communication channel, such as firewalling by firewall enforcement 225 (e.g., to enforce policies that limit certain data from being written to or read from a buffer or memory region) or data filtering (e.g., at the field level) associated with datagram definitions 235. Datagram definition 235 can be based on a data format of data written to or read from the memory-based communication channel (e.g., based on a protocol or other datagram format (including proprietary data formats) defined for the memory-based communication channel), to identify the presence of certain sensitive data to filter or redact such data and effectively protect such information from passing over the memory-based communication channel (e.g., from a more secure or higher trust domain to a less secure or lower trust domain), among other examples.

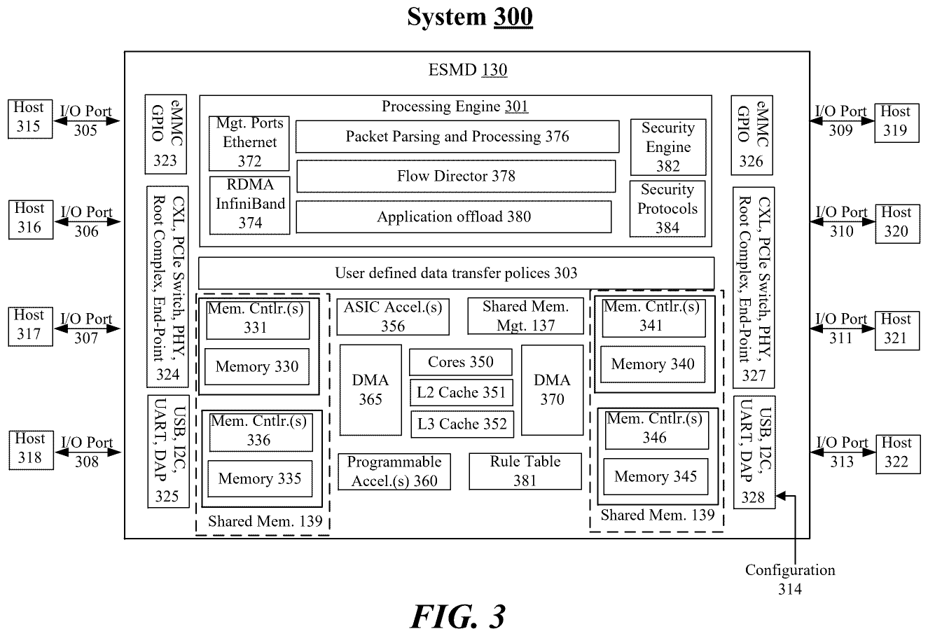

FIG. 3 illustrates an example system 300. According to some examples, as shown in FIG. 3, system 300 includes ESMD 130 coupled with a different set of hosts 313-322 through separate I/O ports 305-313. Hosts 315-322 can be associated with two or more different domains (e.g., domains of different ownership, trust levels, security features or permissions, etc.). Different interconnect protocols may be supported by the various I/O ports 305-313 of ESMD 130 (such as PCIe, CXL, Ethernet, ultra path interconnect (UPI), universal chiplet interconnect express (UCIe), NVLink, embedded multi-media controller (eMMC), general purpose I/O (GIPO), universal serial bus (USB), inter-integrated circuit (I2C), universal asynchronous receiver transmitter (UART), debug adaptor protocol (DA), etc.) and corresponding protocol logic (e.g., 323-324) may be provided on ESMD 130 to enable ESMD 130 to connect to, train, and communicate with the hosts 315-322 over corresponding links.

In some examples, one of the ports from among I/O ports 305-313 or an additional I/O port can be provided as a configuration channel 314, to enable a user or system to interface with ESMD 130 and configure functionality of the ESMD 130, define configurations for connections and communication with ESMD 130 (e.g., by hosts 315-322), define policies and rules that may be applied to memory-based communication channels implemented on ESMD 130, configure cross-domain and/or shared memory services provided by or through the hardware, firmware, and/or software executed on the ESMD 130, among other example features.

According to some examples, as mentioned briefly above for FIG. 1, ESMD 130 can also include shared memory 139. Shared memory 139 can include one or more memory elements (e.g., memory 330, 335, 340, 345), at least a portion of which can be offered as shared memory and implement buffers or memory regions through which two-level isolation schemes can be applied to implement memory-based communication channels between applications or processes hosted by two or more hosts (e.g., 315-323) or by a same host through an exchange of data over or through one or more shared buffers or memory regions. Portions of memory elements 330, 335, 340, 345 arranged to maintain memory regions or buffers designated for use as shared memory may be presented by ESMD 130 to hosts 315-322 as shared memory (e.g., using semantics of the corresponding interconnect protocol through which the host device connects to ESMD 130). Shared memory management 137 of ESMD 130 can be arranged to coordinate access to the shared memory by hosts 315-322 in cooperation with corresponding memory controllers 331, 336, 341, 346. That coordinated access can include performance of read or write memory operations on respective memory elements 330, 335, 340, 345. ESMD 130 can further include direct memory access (DMA) engines 365 or 370 to enable direct memory access (e.g., DMA reads and writes) by hosts 315-322) coupled to ESMD 130 and utilizing one or more memory regions or buffers of shared memory 139 for memory-based communication channels.

In some examples, one or more central processing unit (CPU) processor cores 350 can be provided on ESMD 130 to execute instructions and processes to implement the memory-based communication channel via use of one or more memory regions or buffers maintained in shared memory 139 in order to provide various cross domain services in connection with these one or more memory regions or buffers. The various cross domain service can be based on a respective configuration, isolation rules, and/or isolation policies defined for the one or more memory regions or buffers). The isolation rules and/or isolation policies can be maintained, for example, in rule table 380 at ESMD 130. A cache hierarchy that includes level-2 (L2) cache 351 and level-3 (L3) cache 352 can be provided, and cores 350 can be arranged to cooperate and interoperate with other processing/compute elements provided on the ESMD 130 such as one or more application specific integrated circuit (ASIC) accelerators (accel. (s)) 356 (e.g., cryptographic accelerators, error correction and detection accelerators, etc.) and various programmable hardware accelerators 360 (e.g., graphics accelerators (e.g., GPU), networking accelerators, machine learning accelerators, matrix arithmetic accelerators, field programmable gate array (FPGA)-based accelerators, etc.). Specialized processing functionality and acceleration capabilities (e.g., provided by ASIC accelerator(s) 356 or programmable accelerator(s) 360, etc.) can be leveraged to support memory-based communication channels provided through sharing one or more memory regions or buffers maintained in memory 139 of ESMD 130, based on configurations and rules defined for the memory-based communication channel (e.g., maintained in rule table 380).

According to some examples, logic and/or features can be provided on ESMD 130 to implement various cross domain services in connection with a memory-based communication channel established between hosts 315-322 via use of one or more memory regions or buffers maintained in shared memory 139. Such logic and/or features can be implemented in hardware circuitry (e.g., of accelerator devices (e.g., 356, 360), functional IP blocks, etc.), firmware or software (e.g., executed by cores 350). For these examples, functional cross domain service modules can thereby be implemented, such as modules that assist in emulating particular protocols, corresponding packet processing, and protocol features in a given memory-based communication channel (e.g., providing Ethernet-specific features (e.g., Dynamic Host Configuration Protocol (DHCP)), etc.) using an Ethernet port management module (e.g., 372), or remote DMA (RDMA) and InfiniBand features using an RDMA and/or InfiniBand module (e.g., 374). Various packet parsing and processing may be performed at ESMD 130 using, for example, packet parsing and processing 376, for instance, to parse packets written to a memory-based communication channel shared memory region or buffer and performing additional services on the packet to modify the packet or prepare the packet for reading by another host or device coupled to the memory-based communication channel shared memory region or buffer. Application management tasks may also be performed, including routing tasks (e.g., using a flow director 378) to influence the manner in which data communicated over a memory-based communication channel shared memory region or buffer is consumed and routed by the host or host domain receiving the data (e.g., specifying a process, core, virtual machine (VM), etc. at the host that should handle further processing of the data (e.g., based on packet inspection performed at ESMD 130), among other examples. Application offload 380 can be used to leverage information concerning a network connection of one of the hosts coupled to ESMD 130 to cause data read by the host to be forwarded in a particular manner on a network interface controller or other network element on the device (e.g., to further forward the data communicated over ESMD 130 supported memory-based communication channel to other hosts over the network). In other examples, ESMD 130 can perform various security services on data written and/or read from a memory-based communication channel shared memory region or buffer implemented on ESMD 130, for instance, applying custom or pre-defined security policies or tasks (e.g., using a security engine 382), applying particular security protocols to the communications carried over/through the memory-based communication channel shared memory region or buffer (e.g., IPSec using security protocols 384), among other example cross domain services and functionality.

According to some examples, a traditional internet protocol (IP) network can be at least partially replaced using one or more (or a network of) ESMDs. For these examples, ESMDs such as ESMD 130 can be utilized to implement cross-domain collaboration that allows information sharing to become more intent-centric. For instance, one or more applications executed in a first domain at a first host and the transactions required for communications with other applications of a different domain at the first host or a second host can be first verified for authenticity, security, or other attributes (e.g., based on an application's or domain's requirements), thereby enforcing implicit security. Memory-based communication can also offer a more reliable data transfer and simpler protocol operations for retransmissions and data tracking (e.g., than a more conventional data transfer over a network or interconnect link (which may be emulated by the memory-based communication). Through such simpler operations, ESMDs solutions can offer high-performance communication techniques between interconnecting domain-specific computing environments. Further, memory interfaces in an ESMD can be enforced with access controls and policies for secure operations, such as implementing a permission matrix scheme that can include a type of data-diode which cause memory-based communication channels to operate in a unidirectional fashion with permission-based access controls, such as write-only access, read-only access, and read/write access to access one or more memory-based communication channel shared memory regions or buffers. In other instances, a memory-based communication interface maintained by the ESMD can enable bi-directional communication between different hosts or different host domains. In some examples, separate memory regions or buffers can be used to facilitate each direction of communication (e.g., one memory region/buffer for communication from host A to host B and another memory region/buffer for communication from host B to host A). In such cases, different policies, cross domain services, and even protocols can be applied to each memory region/buffer, based on the disparate characteristics and requirements of the different hosts or host domains, among other example implementations. Generally, these memory-based communication interfaces can be a standard implementation and can also be open-sourced for easier use, community adoption, and public participation in technology contributions without compromising the security and isolation properties of the data transactions. The open implementation also provides transparency of communication procedures over open interfaces to identify any security vulnerabilities.

Traditional communication channels can utilize protocols, which define at least some constraints and costs in achieving compatibility between the connected hosts and applications that are to communicate over these traditional communication channels. An ESMD can enable support for application-defined communication protocols over open interface definitions (and open implementation), allowing customized communication solutions, which are wholly independent of or at least partially based on (and emulate) traditional interconnect protocols. For instance, application-defined communication protocols may enable applications to create their own datagram format, segmentation, encryption, and flow control mechanisms that are decoupled from the protocols used in the ESMD memory-based communication channel interfaces (connecting the ESMD to hosts).

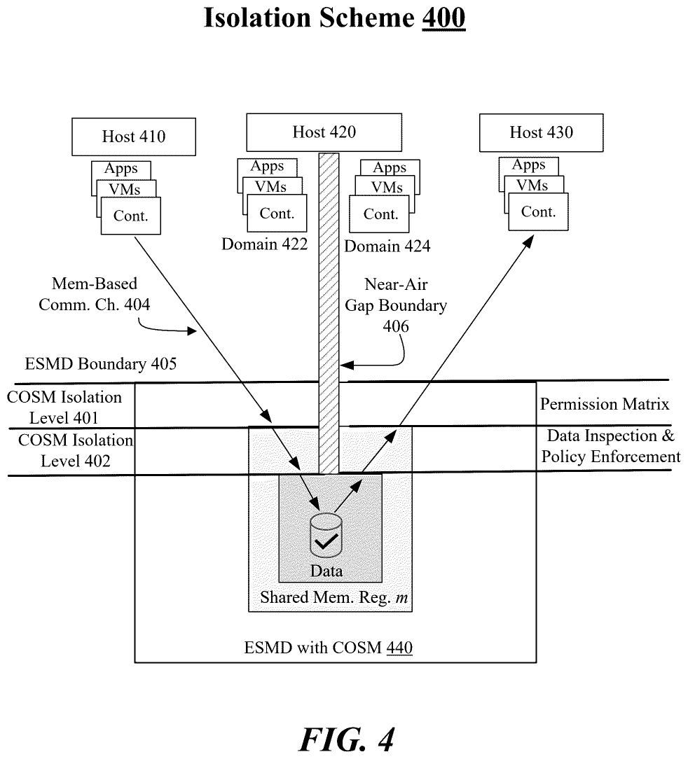

FIG. 4 illustrates an example isolation scheme 400. In some examples, hosts 410, 420 or 430 may be arranged to share access to a shared memory region m maintained at an ESMD with COSM 440. Although not shown in FIG. 4, ESMD with COSM 440 can be configured and/or include similar COSM management circuitry as shown in FIG. 2 for COSM management circuitry 131 and similar functional hardware and logic/features as shown in FIG. 3 for ESMD 130. For these examples, isolation scheme 400 can include establishment of a memory-based communication channel 404 to enable applications, VMs or containers (conts.) hosted by host 410 and host 430 to read and/or write data to shared memory region m based, at least in part, on a first COSM isolation level 401 and a second COSM isolation level 402.

According to some examples, COSM isolation level 401 can be based on a permission matrix scheme that can be arranged to either permit or block applications, VMs or containers hosted by host 410 or host 430 to read/or write data to shared memory region m. For example, the permission matrix can permit applications, VMs or containers hosted by host 410 to conduct at least write operations to shared memory region m and permit applications, VMs or containers hosted by host 430 to conduct at least read operations to shared memory region m. COS isolation level 401 can be implemented at ESMD boundary 405 to allow or block write operations from host 410 or read operations from host 430.

In some examples, COSM isolation level 402 can be based on data inspection and policy enforcement associated with data to be written to or read from shared memory region m. Data inspection and policy enforcement can include inspecting each data transaction (e.g., memory write or read operation) to shared memory region m before that data transaction is processed. For example, policies can be enforced that can include, but are not limited to, verifying a data format and security associated with the data transaction (e.g., ensuring encrypted payloads, structured database records, compliance with industry regulations) and allowing the data transaction if compliant to the policies or taking policy-based actions if the data transaction is not compliant to the policies. Policy-based actions can include, but are not limited to, modifying, deleting, blocking, or generating a notification to a management entity (e.g., a system management orchestrator) to indicate that a non-compliant data transaction was detected for accessing shared memory region m.

According to some examples, a second memory-based communication channel (not shown) similar to memory-based communication channel 404 can be established between two domains 422 and 424 hosted by host 420. For these examples, the second memory-based communication channel can be subject to the same two-level isolation scheme that effectively creates a near-air gap boundary 406 between applications, VMs and containers included in domain 422 and applications, VMs and containers included in domain 424. The near-air gap boundary 406 is shown in FIG. 4 to indicate that a two-level isolation scheme such as example isolation scheme 400 can emulate an air-gap (physical isolation) of shared memory region m when shared between two domains or shared between two hosts hosting respective domains.

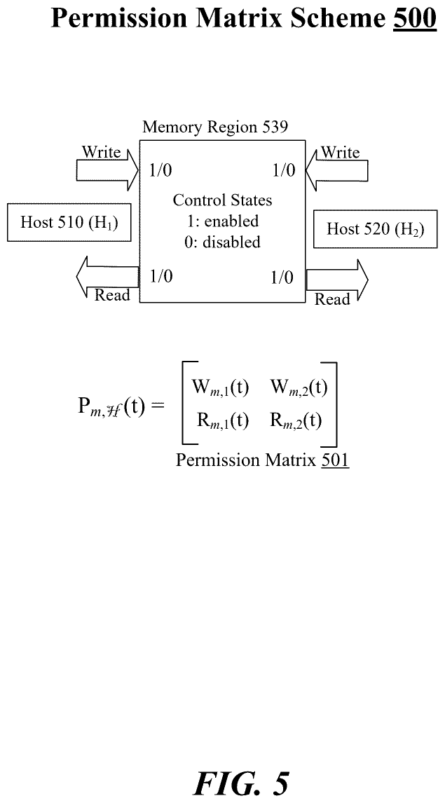

FIG. 5 illustrates an example permission matrix scheme 500. According to some examples, example permission matrix scheme 500 can represent a portion of a controlled shared memory (COSM) framework implemented at an ESMD. For these examples, permission matrix scheme 500 includes use of permission matrix 501 for fine-grained filtering and control at the granularity of individual hosts that are shown in FIG. 5 as host 510 and host 520 and at the granularity of an individual memory region shown in FIG. 5 as memory region 539. Memory region 539, for example, is maintained at the ESMD and is arranged to be shared by host 510 and host 520. For example permission matrix 501, “Pm” indicates that this is a permission matrix for shared memory region m and “H” denotes a set of distinct hosts {H₁, H₂, . . . ,Hₙ, . . . , H_{N}} that can participate in permission matrix scheme 500 and “m” denotes a set of distinct (non-overlapping) memory regions [M₁, M₂, . . . , Mₘ, . . . , M_{M}]. A given memory region Mₘ can be characterized by a memory address of the start of memory region Mₘ and a memory address of the end of memory region Mₘ.

In some examples, memory region 539 can represent a given memory region Mₘ. and host 510 can represent a given host H₁ and host 520 can represent a second given host H₂. For these examples, host 510 and host 520 can be configured for sharing memory region 539 based on an underlying memory technology or standard (e.g., CXL). Both host 510 and host 520 can have two degrees of freedom for sharing memory region 539: write permission and read permission, which may change with time t. The variable “t” indicates a type of time-dependent control of shared memory region 539. For example permission matrix 501, if W_{m,1}(t)=1, host 510(H₁) is permitted to write data to memory region 539(m) at time t and if W_{m,1}(t)=0, host 510(H₁) is blocked or prohibited from writing data to memory region 539(m) at time t. Also, if R_{m,1}(t)=1, host 510(H₁) is permitted to read data from memory region 539(m) at time t and if R_{m,1}(t)=0, host 510(H₁) is blocked or prohibited from writing data to memory region 539(m) at time t. Similarly, if W_{m,2}(t)=1, host 520(H₂) is permitted to write data to memory region 539(m) at time t and if W_{m,2}(t)=0, host 520(H₂) is blocked or prohibited from writing data to memory region 539(m) at time t. Also, if R_{m,2}(t)=1, host 520(H₂) is permitted to read data from memory region 539(m) at time t and if R_{m,2}(t)=0, host 520(H₁) is blocked or prohibited from writing data to memory region 539(m) at time t.

According to some examples, permission matrix 501 can be used as a mechanism to ensure that hosts 510 or 520 can access shared memory region 539 with tailored read/write permissions. For example, shared memory region 539 may be a critical shared memory region and host 510 may need to perform real-time updates to data maintained in shared memory region 539 to perform real-time updates and thus may have write access to shared memory region 539, while other hosts such as host 520 are restricted to read-only permissions to prevent accidental overwrites or data corruption. This type of fine-granular control enables precise enforcement of access policies, minimizing risks of unauthorized data manipulation or accidental interference in multi-host environments.

In some examples, permission matrix 501 can allow for a type of permission matrix filtering that facilitates dynamic and context-aware memory management. For example, an ESMD such as ESMD 130 can be configured to update permissions on the fly based on an operational state of a system or based on application requirements. Updated permissions can include granting temporary write access to a host for a specific task and then revoking the permission once the task is complete. This type of flexibility can be important in scenarios involving hierarchical or distributed memory allocation, where different hosts or processes may have varying levels of privilege. By enabling a fine-granular level of control, the ESMD can improve both security and performance by allowing shared memory that can be utilized efficiently without compromising the integrity of data or system operations.

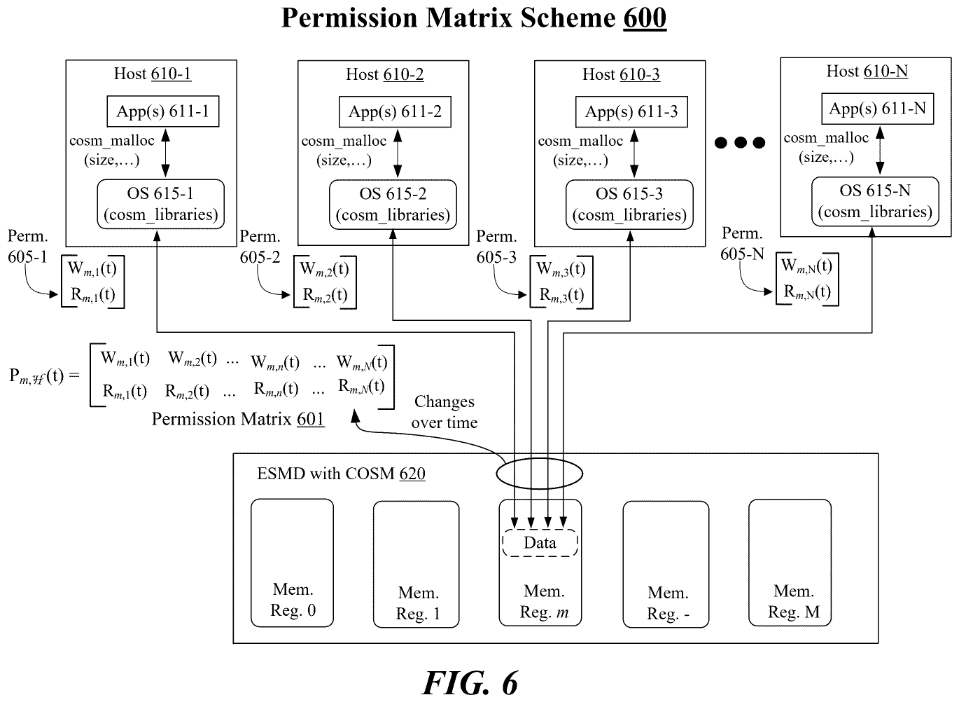

FIG. 6 illustrates an example permission matrix scheme 600. According to some examples, permission matrix scheme 600 shows use of a permission matrix 601 to control access by applications 611-1 to 611-N hosted by Hosts 610-1 to 610N to data maintained in shared memory region (mem. reg.) m maintained at ESMD with COSM 620. Although not shown in FIG. 6, ESMD with COSM 620 can be configured to include similar COSM management circuitry as shown in FIG. 2 for COSM management circuitry 131 and similar functional hardware and logic/features as shown in FIG. 3 for ESMD 130. For these examples, the variables of permission matrix 601 can be used in a similar manner as mentioned above for permission matrix 501 to indicate write or read permissions of hosts 610-1 to 610-N at time t. The individual permissions included in permission matrix 601 are shown in FIG. 6 as permissions 605-1 to 605-N.

In some examples, logic and/or features of COSM management circuitry for ESMD with COSM 620 (e.g., control plane unit 132 of COSM management circuitry 131) can moderate access control to memory region m by setting permissions for each host from among hosts 610-1 to 610-N through permission matrix 601. For these examples, once all permissions to access memory region are completed, applications 611-1 to 611-N can use library functions (cosm_libraries) maintained by respective OSs 615-1 to 615-N to place memory allocation requests (cosm_malloc size, . . . ) to allocate memory addresses and to access those allocated memory addresses via read or write operations.

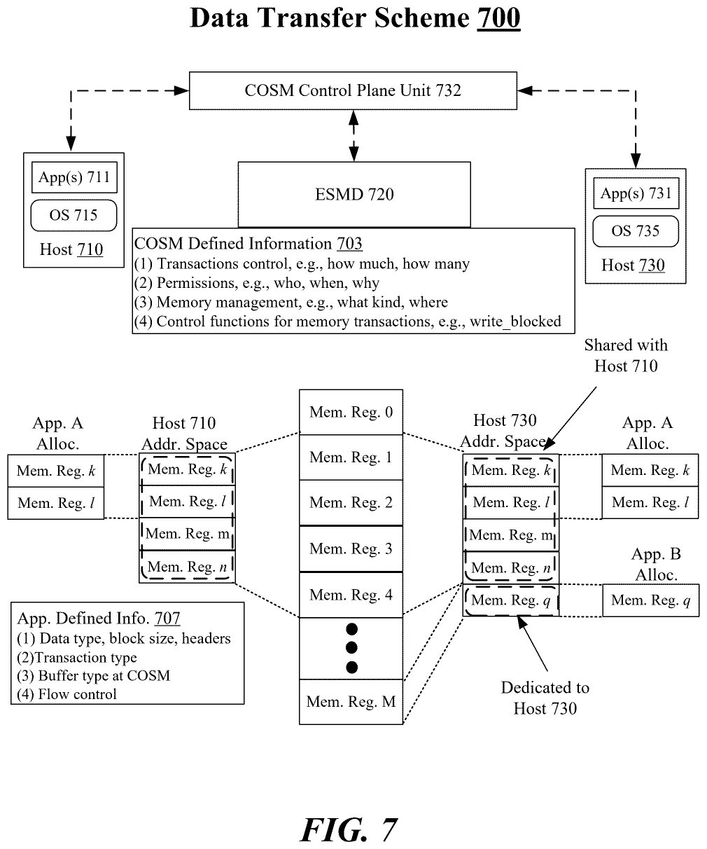

FIG. 7 illustrates an example data transfer scheme 700. In some examples, as shown in FIG. 7, data transfer scheme 700 includes a COSM control plane unit 732 in communication with an ESMD 720 and in communication with hosts 710 and 720. For these examples, although not shown in FIG. 7, COSM control plane unit 732 can be configured to include similar logic and/or features included in COSM control plane unit 132 of COSM management circuitry 131 described above for and shown in FIG. 2. Also, ESMD 720 can include similar functional hardware and logic/features described above for and shown in FIG. 3.

According to some examples, data transfer scheme 700 can illustrate a general approach for an end-to-end data transfer between applications hosted by hosts 710 and 720 via a memory-based communication channel established through shared memory regions of a shared memory maintained at ESMD 720. For example, COSM defined information 703 indicates: (1) transactions control; (2) permissions; (3) memory management; and (4) control functions for memory transactions for this established memory-based communication channel. Item (1) related to transaction control can be related to data inspection and policy enforcement that may be implemented in a similar manner as mentioned above for isolation scheme 400 (COSM isolation level 402). Item (2) related to permissions may be implemented in a similar manner as mentioned above for isolation scheme 400 (COSM isolation level 401) and for permission matrix scheme 500. Item (3) related to memory management can result in host 710 sharing memory regions 1-4 with host 720 and also can result in host 720 having exclusive access to memory region M. Item (4) related to control functions for memory transactions can also be related to data inspection and policy enforcement implemented in a similar manner as mentioned above for isolation scheme 400 (COSM isolation level 402).

In some examples, hosts 710 and 720 can allocate their respective address space that map to shared memory regions 1-4 to applications included in application(s) 711 and 713. For example, host 710 and host 730 address spaces that include memory regions k, l, m, n are mapped to shared memory regions 1-4. Also, host 730′s address space q is shown in FIG. 7 as mapping to memory region M that is not shared between hosts 710 and 730. Application A of host 710 can request and receive an allocation of memory region k and/that maps to shared memory region 1 and 2. Similarly, application A of host 730 can request and receive an allocation of memory region k and/that also maps to shared memory region 1 and 2. Also, application B of host 730 can request and receive an allocation of memory region q that maps to memory region M.

According to some examples, data transfers through shared memory regions 1-4 can be conducted with user defined protocol data units (UPDUs). For these examples, applications can determine a data structure to be used for sharing over shared memory regions 0-4. This can allow applications to create UPDUs over the shared memory, whereby applications can define data block specifications, such as data type, block size, and headers. As shown in FIG. 7 for data transfer scheme 700, application defined information item (1) data type, block size, headers can indicate how data block specifications are defined. Also, item (2) can define transaction types (e.g., read/write), item (3) can define a buffer type to use at an ESMD with COSM, and item (4) can define a flow control.

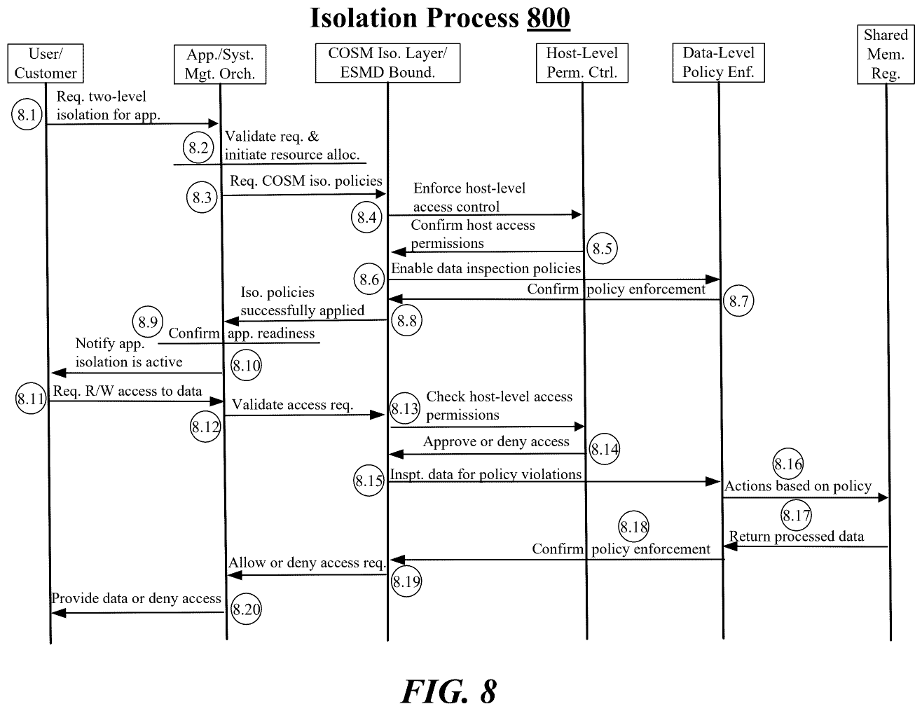

FIG. 8 illustrates an example isolation process 800. According to some examples, at 8.1, a user/customer of an application hosted by a host computing platform (e.g., host 710) can initiate a request for multiple isolations for memory transactions of an application (e.g., included in application(s) 711). The request for multiple isolations can be based on a need for a higher level of security but a desire to have performance gain possible with use of shared memory by the application to communicate with other applications or processes at other hosts and or in other host domains.

In some examples, at 8.2, an application/system management orchestrator (app./syst. mgt. orch.) can validate the request for multiple isolations and if validated, initiate resource allocation. For these examples, validation can be based on whether the user has authorization to request multiple isolations. Resource allocation can include a request to use shared memory maintained at an ESMD with COSM (e.g., maintained at ESMD 720).

According to some examples, at 8.3, the application/system management orchestrator can initiate a request to the ESMD with COSM for isolation (iso.) policies responsive to the validated request for multiple isolations. For these examples, the COSM isolation policies can include a two-level isolation similar to isolation scheme 400 that implements a permission matrix for a first level of isolation and data inspection and policy enforcement for a second level of isolation.

In some examples, at 8.4, logic and/or features of COSM management circuitry of the ESMD with COSM (e.g., COSM control plane unit 132) can be configured to enforce host-level access control at a first COSM isolation (iso.) layer/ESMD boundary. For these examples, the first COSM isolation layer can include use of a permission matrix (e.g., similar to permission matrix 501 or permission matrix 601) that can indicate what types of read or write access that the host that is hosting the application is permitted to have.

According to some examples, at 8.5, the logic and/or features of COSM management circuitry of the ESMD with COSM can confirm host access permissions. For these examples, an indications or whether the host has read-only access, write-only access, read/write access to shared memory maintained at the ESMD with COSM is confirmed. In other examples, if the host has no access to shared memory, then the application hosted by the host is blocked from accessing the shared memory for any type of memory transaction.

In some examples, at 8.6, since the host was confirmed to have access permission, data inspection policies are enabled.

According to some examples, at 8.7, the logic and/or features of COSM management circuitry of the ESMD with COSM can confirm that policy enforcement has been enabled for shared memory maintained at the ESMD with COSM. For these examples, confirmation can include setting the enforcement policies to be implemented for the second level of isolation for use of the shared memory maintained at the ESMD with COSM.

In some examples, at 8.8, isolation (iso.) policies successfully applied can be indicated to the application/system management orchestrator by the logic and/or features of COSM management circuitry of the ESMD with COSM. For these examples, this indication can signal that two-level isolation is now set/established for the application to use shared memory maintained at the ESMD with COSM.

According to some examples, at 8.9, the application/system management orchestrator can confirm that the application is now ready to use the shared memory maintained at the ESMD with COSM.

In some examples, at 8.10, the user/customer can be notified that the application isolation is active. For these examples, the notification can indicate that multiple isolations for the application to use shared memory are active.

According to some examples, at 8.11, the user/customer can cause or initiate a request for read or write (R/W) access to shared memory maintained at the ESMD with COSM.

In some examples, at 8.12, the application/system management orchestrator can validate the request based on the user/customer being authorized to access the shared memory maintained at the ESMD with COSM.

In some examples, at 8.13, logic and/or features of COSM management circuitry of the ESMD with COSM can be configured to check host-level access permissions at a first COSM isolation (iso.) layer/ESMD boundary. For these examples, a permission matrix for the host that hosts the application is checked to see what types of read or write access are permitted.

According to some examples, at 8.14, logic and/or features of COSM management circuitry of the ESMD with COSM can approve or deny access to the shared memory based on the permission matrix. For these examples, the access request can include a read access request and the permission matrix can indicate that a read access is permitted for the host that hosts the application. As a result, the access request passes through the first layer of isolation.

In some examples, at 8.15, logic and/or features of COSM management circuitry of the ESMD with COSM can be configured to inspect the access request and/or the data to be accessed in the shared memory for policy violations. For these examples, the inspection can be a part of the second layer of isolation.

According to some examples, at 8.16, logic and/or features of COSM management circuitry of the ESMD with COSM (e.g., COSM data plane unit 133) can be configured to take actions based on policy established as mentioned above at 8.6 and 8.7. For these examples, actions can include allowing access or modifying or blocking access to the data stored to the shared memory maintained at the ESMD with COSM. If the actions included modifying or blocking access, additional actions can also include sending a notification to the application/system management orchestrator that blocking or modifying actions were taken.

In some examples, at 8.17, processed data is returned from the shared memory region.

According to some examples, at 8.18, logic and/or features of COSM management circuitry of the ESMD with COSM can confirm that policy enforcement that was part of the second level of isolation for the access request to the shared memory was completed/implemented.

In some examples, at 8.19, logic and/or features of COSM management circuitry of the ESMD with COSM can indicate to the application/system management orchestrator if the access request was allowed or denied. In some other examples, an indication of whether the access request was modified may also be indicated.

According to some examples, at 8.20. the application/system management orchestrator can either provide the data or deny access to the data for the user/customer based on the indication received at 8.19. Isolation process 800 then comes to an end.

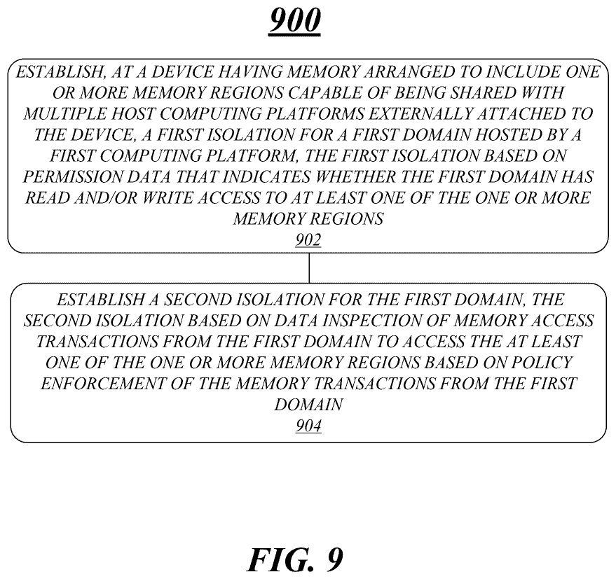

FIG. 9 illustrates an example logic flow 900. Logic flow 900 can be representative of some or all of the operations executed by one or more logic, features, or devices described herein, such as logic and/or features of ESMD 130 supported by COSM management circuitry 131 or logic and/or features of other ESMDs such as ESMD with COSM 420, ESMD with COSM 620 or ESMD 720.

In some examples, as shown in FIG. 9, logic flow 900 at block 902 can establish, at a device having memory arranged to include one or more memory regions capable of being shared with multiple host computing platforms externally attached to the device, a first isolation for a first domain hosted by a first computing platform, the first isolation based on permission data that indicates whether the first domain has read and/or write access to at least one of the one or more memory regions. For these examples, COSM management circuitry such as included in ESMD 130, ESMD with COSM 420, ESMD with COSM 620 or ESMD with COSM 820 can establish the first isolation based on a permission matrix (e.g., permission matrix 501 or 601).

According to some examples, as shown in FIG. 9, logic flow 900 at block 904 can establish a second isolation for the first domain, the second isolation based on data inspection of memory access transactions from the first domain to access the at least one of the one or more memory regions based on policy enforcement of the memory transactions from the first domain. For these examples, COSM management circuitry such as included in ESMD 130, ESMD with COSM 420, or ESMD with COSM 820 can establish the second isolation at shared memory of these devices.

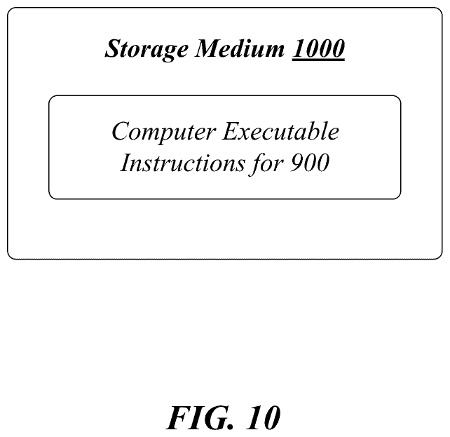

FIG. 10 illustrates an example of a storage medium. As shown in FIG. 10, the storage medium includes a storage medium 1000. The storage medium 1000 may comprise an article of manufacture. In some examples, storage medium 1000 can include any non-transitory computer readable medium or machine readable medium, such as an optical, magnetic or semiconductor storage. Storage medium 1000 can store various types of computer executable instructions, such as instructions to implement logic flow 900. Examples of a computer readable or machine readable storage medium can include any tangible media capable of storing electronic data, including volatile memory or non-volatile memory, removable or non-removable memory, erasable or non-erasable memory, writeable or re-writeable memory, and so forth. Examples of computer executable instructions can include any suitable type of code, such as source code, compiled code, interpreted code, executable code, static code, dynamic code, object-oriented code, visual code, and the like. The examples are not limited in this context.

One or more aspects of at least one example can be implemented by representative instructions stored on a machine-readable medium which represents various logic within the processor, which when read by a machine causes the machine to fabricate logic to perform the techniques described herein. Such representations, known as “IP cores” can be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, various examples also include non-transitory, tangible machine-readable media containing instructions or containing design data, such as Hardware Description Language (HDL), which defines structures, circuits, apparatuses, processors and/or system features described herein. Such examples may also be referred to as program products.

In some cases, an instruction converter can be used to convert an instruction from a source instruction set to a target instruction set. For example, the instruction converter can translate (e.g., using static binary translation, dynamic binary translation including dynamic compilation), morph, emulate, or otherwise convert an instruction to one or more other instructions to be processed by the core. The instruction converter can be implemented in software, hardware, firmware, or a combination thereof. The instruction converter may be on processor, off processor, or part on and part off processor.

Various examples can be implemented using hardware elements, software elements, or a combination of both. In some examples, hardware elements can include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements can include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The following examples pertain to additional examples of technologies disclosed herein.

Example 1. An example apparatus can include an I/O interface, a memory arranged to include one or more memory regions shared with multiple host computing platforms externally attached to the apparatus, and circuitry. The circuitry can be configured to establish a first isolation for a first domain hosted by a first computing platform. The first isolation can be based on permission data that indicates whether the first domain has read and/or write access to at least one of the one or more memory regions. The circuitry can also be configured to establish a second isolation for the first domain. The second isolation can be based on data inspection of memory access transactions from the first domain to access the at least one of the one or more memory regions based on policy enforcement of the memory transactions from the first domain.

Example 2. The apparatus of example 1, the circuitry can be further configured to establish a first isolation for a second domain hosted by the first computing platform. The first isolation for the second domain can be based on the permission data that also indicates whether the second domain has read and/or write access to the at least one of the one or more memory regions. The circuitry can also be configured to establish a second isolation for the second domain. The second isolation for the second domain can be based on data inspection of memory access transactions from the second domain to access the at least one of the one or more memory regions based on policy enforcement of the memory transactions from the second domain.

Example 3. The apparatus of example 2, the first domain can be a first application and the second domain can be a second application. Read and/or write access to the at least one or more memory regions by the first application and the second application can provide a memory-based communication channel between the first application and the second application.

Example 4. The apparatus of example 1, the circuitry can be further configured to establish a first isolation for a second domain hosted by a second computing platform. The first isolation for the second domain can be based on the permission data that also indicates whether the second domain has read and/or write access to the at least one of the one or more memory regions. The circuitry can also be configured to establish a second isolation for the second domain. The second isolation for the second domain can be based on data inspection of memory access transactions from the second domain to access the at least one of the one or more memory regions based on policy enforcement of the memory transactions from the second domain.

Example 5. The apparatus of example 4, the first domain can be a first application and the second domain can be a second application. Read and/or write access to the at least one or more memory regions by the first application and the second application can provide a memory-based communication channel between the first application hosted by the first computing platform and the second application hosted by the second computing platform.

Example 6. The apparatus of example 1, data inspection of memory transactions from the first domain to access the at least one of the one or more memory regions can include a verification of a data format and security associated with the memory transactions based on policy enforcement of the memory transactions from the first domain.

Example 7. The apparatus of example 6, policy enforcement actions associated with policy enforcement can include blocking, modifying, deleting or blocking the memory transaction from the first domain.

Example 8. The apparatus of example 1, the I/O interface can be one or more ports to support links according to one or more of a PCIe-based protocol, a CXL-based protocol, or an NVLink-based protocol.

Example 9. An example method can include establishing, at a device having memory arranged to include one or more memory regions shared with multiple host computing platforms externally attached to the device, a first isolation for a first domain hosted by a first computing platform. The first isolation can be based on permission data that indicates whether the first domain has read and/or write access to at least one of the one or more memory regions. The method can also include establishing a second isolation for the first domain. The second isolation can be based on data inspection of memory access transactions from the first domain to access the at least one of the one or more memory regions based on policy enforcement of the memory transactions from the first domain.

Example 10. The method of example 9 can also include establishing a first isolation for a second domain hosted by the first computing platform. The first isolation for the second domain can be based on the permission data that also indicates whether the second domain has read and/or write access to the at least one of the one or more memory regions. The method can also include establishing a second isolation for the second domain The second isolation for the second domain can be based on data inspection of memory access transactions from the second domain to access the at least one of the one or more memory regions based on policy enforcement of the memory transactions from the first domain.

Example 11. The method of example 10, the first domain can be a first application and the second domain can be a second application. Read and/or write access to the at least one or more memory regions by the first application and the second application can provide a memory-based communication channel between the first application and the second application.

Example 12. The method of example 9, can also include establishing the first isolation for a second domain hosted by a second computing platform. The first isolation for the second domain can be based on the permission data that also indicates whether the second domain has read and/or write access to the at least one of the one or more memory regions. The method can also include establishing a second isolation for the second domain. The second isolation for the second domain can be based on data inspection of memory access transactions from the second domain to access the at least one of the one or more memory regions based on policy enforcement of the memory transactions from the second domain.

Example 13. The method of example 12, the first domain can be a first application and the second domain can be a second application, Read and/or write access to the at least one or more memory regions by the first application and the second application can provide a memory-based communication channel between the first application hosted by the first computing platform and the second application hosted by the second computing platform.

Example 14. The method of example 9, data inspection of memory transactions from the first domain to access the at least one of the one or more memory regions can include a verification of a data format and security associated with the memory transactions based on policy enforcement of the memory transactions from the first domain. Policy enforcement actions associated with policy enforcement can include blocking, modifying, deleting or blocking the memory transaction from the first domain.

Example 15. An example at least one machine readable medium can include a plurality of instructions that in response to being executed by a system, causes the system to establish, at a device having memory arranged to include one or more memory regions shared with multiple host computing platforms externally attached to the device, a first isolation for a first domain hosted by a first computing platform. The first isolation can be based on permission data that indicates whether the first domain has read and/or write access to at least one of the one or more memory regions. The instructions can also cause the system to establish a second isolation for the first domain. The second isolation can be based on data inspection of memory access transactions from the first domain to access the at least one of the one or more memory regions based on policy enforcement of the memory transactions from the first domain.

Example 16. The at least one machine readable medium of example 15, the instructions can further cause the system to establish a first isolation for a second domain hosted by the first computing platform. The first isolation for the second domain can be based on the permission data that also indicates whether the second domain has read and/or write access to the at least one of the one or more memory regions. The instructions can also cause the system to establish a second isolation for the second domain. The second isolation for the second domain based on data inspection of memory access transactions from the second domain to access the at least one of the one or more memory regions based on policy enforcement of the memory transactions from the first domain.

Example 17. The at least one machine readable medium of example 16, the first domain can be a first application and the second domain can be a second application. Read and/or write access to the at least one or more memory regions by the first application and the second application can provide a memory-based communication channel between the first application and the second application.

Example 18. The at least one machine readable medium of example 15, the instructions can further cause the system to establish a first isolation for a second domain hosted by a second computing platform. The first isolation for the second domain can be based on the permission data that also indicates whether the second domain has read and/or write access to the at least one of the one or more memory regions. The instructions can also cause the system to establish a second isolation for the second domain. The second isolation for the second domain can be based on data inspection of memory access transactions from the second domain to access the at least one of the one or more memory regions based on policy enforcement of the memory transactions from the second domain.

Example 19. The at least one machine readable medium of example 15, the first domain can be a first application and the second domain can be a second application. Read and/or write access to the at least one or more memory regions by the first application and the second application can provide a memory-based communication channel between the first application hosted by the first computing platform and the second application hosted by the second computing platform.

Example 20. The at least one machine readable medium of example 15, data inspection of memory transactions from the first domain to access the at least one of the one or more memory regions can include a verification of a data format and security associated with the memory transactions based on policy enforcement of the memory transactions from the first domain. Policy enforcement actions associated with policy enforcement can include blocking, modifying, deleting or blocking the memory transaction from the first domain.

It is emphasized that the Abstract of the Disclosure is provided to comply with 37 C.F.R. Section 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.?

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
an input/output (I/O) interface;
a memory arranged to include one or more memory regions shared with multiple host computing platforms externally attached to the apparatus; and
circuitry configured to:
establish a first isolation for a first domain hosted by a first computing platform, the first isolation based on permission data that indicates whether the first domain has read and/or write access to at least one of the one or more memory regions; and
establish a second isolation for the first domain, the second isolation based on data inspection of memory access transactions from the first domain to access the at least one of the one or more memory regions based on policy enforcement of the memory transactions from the first domain.

2. The apparatus of claim 1, wherein the circuitry is further configured to:
establish a first isolation for a second domain hosted by the first computing platform, the first isolation for the second domain based on the permission data that also indicates whether the second domain has read and/or write access to the at least one of the one or more memory regions; and
establish a second isolation for the second domain, the second isolation for the second domain based on data inspection of memory access transactions from the second domain to access the at least one of the one or more memory regions based on policy enforcement of the memory transactions from the second domain.

3. The apparatus of claim 2, wherein the first domain comprises a first application and the second domain comprises a second application, and wherein read and/or write access to the at least one or more memory regions by the first application and the second application provides a memory-based communication channel between the first application and the second application.

4. The apparatus of claim 1, wherein the circuitry is further configured to:
establish a first isolation for a second domain hosted by a second computing platform, the first isolation for the second domain based on the permission data that also indicates whether the second domain has read and/or write access to the at least one of the one or more memory regions; and
establish a second isolation for the second domain, the second isolation for the second domain based on data inspection of memory access transactions from the second domain to access the at least one of the one or more memory regions based on policy enforcement of the memory transactions from the second domain.

5. The apparatus of claim 4, wherein the first domain comprises a first application and the second domain comprises a second application, and wherein read and/or write access to the at least one or more memory regions by the first application and the second application provides a memory-based communication channel between the first application hosted by the first computing platform and the second application hosted by the second computing platform.

6. The apparatus of claim 1, wherein data inspection of memory transactions from the first domain to access the at least one of the one or more memory regions includes a verification of a data format and security associated with the memory transactions based on policy enforcement of the memory transactions from the first domain.

7. The apparatus of claim 6, wherein policy enforcement actions associated with policy enforcement include blocking, modifying, deleting or blocking the memory transaction from the first domain.

8. The apparatus of claim 1, wherein the I/O interface comprises one or more ports to support links according to one or more of a Peripheral Component Interconnect Express (PCIe)-based protocol, a Compute Express Link (CXL)-based protocol, or an NVLink-based protocol.

9. A method comprising:
establishing, at a device having memory arranged to include one or more memory regions shared with multiple host computing platforms externally attached to the device, a first isolation for a first domain hosted by a first computing platform, the first isolation based on permission data that indicates whether the first domain has read and/or write access to at least one of the one or more memory regions; and
establishing a second isolation for the first domain, the second isolation based on data inspection of memory access transactions from the first domain to access the at least one of the one or more memory regions based on policy enforcement of the memory transactions from the first domain.

10. The method of claim 9, the method further comprising:
establishing a first isolation for a second domain hosted by the first computing platform, the first isolation for the second domain based on the permission data that also indicates whether the second domain has read and/or write access to the at least one of the one or more memory regions; and
establishing a second isolation for the second domain, the second isolation for the second domain based on data inspection of memory access transactions from the second domain to access the at least one of the one or more memory regions based on policy enforcement of the memory transactions from the first domain.

11. The method of claim 10, wherein the first domain comprises a first application and the second domain comprises a second application, and wherein read and/or write access to the at least one or more memory regions by the first application and the second application provides a memory-based communication channel between the first application and the second application.

12. The method of claim 9, the method further comprising:
establishing the first isolation for a second domain hosted by a second computing platform, the first isolation for the second domain based on the permission data that also indicates whether the second domain has read and/or write access to the at least one of the one or more memory regions; and
establishing a second isolation for the second domain, the second isolation for the second domain based on data inspection of memory access transactions from the second domain to access the at least one of the one or more memory regions based on policy enforcement of the memory transactions from the second domain.

13. The method of claim 12, wherein the first domain comprises a first application and the second domain comprises a second application, and wherein read and/or write access to the at least one or more memory regions by the first application and the second application provides a memory-based communication channel between the first application hosted by the first computing platform and the second application hosted by the second computing platform.

14. The method of claim 9, wherein data inspection of memory transactions from the first domain to access the at least one of the one or more memory regions includes a verification of a data format and security associated with the memory transactions based on policy enforcement of the memory transactions from the first domain, and wherein policy enforcement actions associated with policy enforcement include blocking, modifying, deleting or blocking the memory transaction from the first domain.

15. At least one machine readable medium comprising a plurality of instructions that in response to being executed by a system, causes the system to:
establish, at a device having memory arranged to include one or more memory regions shared with multiple host computing platforms externally attached to the device, a first isolation for a first domain hosted by a first computing platform, the first isolation based on permission data that indicates whether the first domain has read and/or write access to at least one of the one or more memory regions; and
establish a second isolation for the first domain, the second isolation based on data inspection of memory access transactions from the first domain to access the at least one of the one or more memory regions based on policy enforcement of the memory transactions from the first domain.

16. The at least one machine readable medium of claim 15, the instructions to further cause the system to:
establish a first isolation for a second domain hosted by the first computing platform, the first isolation for the second domain based on the permission data that also indicates whether the second domain has read and/or write access to the at least one of the one or more memory regions; and
establish a second isolation for the second domain, the second isolation for the second domain based on data inspection of memory access transactions from the second domain to access the at least one of the one or more memory regions based on policy enforcement of the memory transactions from the first domain.

17. The at least one machine readable medium of claim 16, wherein the first domain comprises a first application and the second domain comprises a second application, and wherein read and/or write access to the at least one or more memory regions by the first application and the second application provides a memory-based communication channel between the first application and the second application.

18. The at least one machine readable medium of claim 15, the instructions to further cause the system to:
establish a first isolation for a second domain hosted by a second computing platform, the first isolation for the second domain based on the permission data that also indicates whether the second domain has read and/or write access to the at least one of the one or more memory regions; and
establish a second isolation for the second domain, the second isolation for the second domain based on data inspection of memory access transactions from the second domain to access the at least one of the one or more memory regions based on policy enforcement of the memory transactions from the second domain.

19. The at least one machine readable medium of claim 15, wherein the first domain comprises a first application and the second domain comprises a second application, and wherein read and/or write access to the at least one or more memory regions by the first application and the second application provides a memory-based communication channel between the first application hosted by the first computing platform and the second application hosted by the second computing platform.

20. The at least one machine readable medium of claim 15, wherein data inspection of memory transactions from the first domain to access the at least one of the one or more memory regions includes a verification of a data format and security associated with the memory transactions based on policy enforcement of the memory transactions from the first domain, and wherein policy enforcement actions associated with policy enforcement include blocking, modifying, deleting or blocking the memory transaction from the first domain.
